(19) United States
(12) Patent Application Publication
(10) Pub. No.: US 2024/0338592 A1
(43) Pub. Date: Oct. 10, 2024

(54) SYSTEMS, METHODS, AND APPARATUSES FOR GENERATING A DIGITAL TWIN OF A RESOURCE USING PARTIAL SENSOR DATA AND ARTIFICIAL INTELLIGENCE

(71) Applicant: BANK OF AMERICA CORPORATION, Charlotte, NC (US)

(72) Inventors: Vijay Kumar Yarabolu, Hyderabad (IN); Gowthaman Sundararaj, Chennai (IN)

(73) Assignee: BANK OF AMERICA CORPORATION, Charlotte, NC (US)

(21) Appl. No.: 18/131,434

(22) Filed: Apr. 6, 2023

(51) Int. Cl. G06N 20/00

(52) U.S. Cl. CPC G06N 20/00

(57) ABSTRACT

Systems, computer program products, and methods are described herein for generating a digital twin or a resource using partial sensor data and artificial intelligence. The present invention is configured to receive resource sensor data from a plurality of sensors, wherein the plurality of sensors is associated with a resource; apply a sensor data analyzer engine to the resource sensor data; determine, by the sensor data analyzer engine, whether at least one sensor anomaly of the resource sensor data is present; apply an on-demand synthetic data generator to the at least one sensor anomaly; generate synthetic sensor data associated with the resource, wherein the synthetic sensor data is based on a real-time pattern of the resource sensor data from the plurality of sensors; and generate, based on the resource sensor data from the plurality of sensors and the synthetic sensor data, a digital twin of the resource.

### FIELD OF THE INVENTION

The present invention embraces a system for generating a digital twin of a resource using partial sensor data and artificial intelligence.

### BACKGROUND

Managers and users of digital environments, such as a metaverse environment, may wish to accurately capture real-world resources as digital resources for the digital environment, but may have difficulty when certain hardware components used to generate these digital resources are not functioning correctly. For instance, and where a plurality of sensors may be used to capture the characteristics of the resource, then the issue may arise where at least one of the sensors is not functioning correctly so the digital resource cannot be generated accurately. The issue may further be exacerbated when the sensors are interconnected to gather system logs and gather telemetry data, thus when one sensor malfunctions, the overall system may be impacted. Thus, there exists a need to implement a system that accurately generate digital resources for a digital environment even when at least one sensor is malfunctioning.

Applicant has identified a number of deficiencies and problems associated with generating a digital twin of a resource using partial sensor data and artificial intelligence. Through applied effort, ingenuity, and innovation, many of these identified problems have been solved by developing solutions that are included in embodiments of the present disclosure, many examples of which are described in detail herein.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for generating a digital twin of a resource using partial sensor data and artificial intelligence is provided. In some embodiments, the system may comprise a memory device with computer-readable program code stored thereon; at least one processing device operatively coupled to the at least one memory device and the at least one communication device, wherein executing the computer-readable code is configured to cause the at least one processing device to: receive resource sensor data from a plurality of sensors, wherein the plurality of sensors is associated with a resource; apply a sensor data analyzer engine to the resource sensor data; determine, by the sensor data analyzer engine, whether at least one sensor anomaly of the resource sensor data is present; apply an on-demand synthetic data generator to the at least one sensor anomaly; generate, by the on-demand synthetic data generator, synthetic sensor data associated with the resource, wherein the synthetic sensor data is based on a real-time pattern of the resource sensor data from the plurality of sensors; and generate, based on the resource sensor data from the plurality of sensors and the synthetic sensor data, a digital twin of the resource.

In some embodiments, the on-demand synthetic data generator is configured to: generate a pattern of resource sensor data based on the resource sensor data, wherein the resource sensor data is received at a present time; and generate, based on the pattern of resource sensor data, the synthetic sensor data.

In some embodiments, the processing device is further configured to: identify resource sensor data associated with at least one resource; create a first training dataset comprising the resource sensor data associated with the at least one resource; and train the sensor data analyzer engine in a first stage using the first training dataset. In some embodiments, the resource sensor data associated with the at least one resource comprises at least one of resource sensor data for one resource or resource sensor data for a plurality of resources.

In some embodiments, the processing device is further configured to: apply, in response to the generation of the digital twin, at least one of an augmented data or an event simulation to the digital twin; test the digital twin based on the application of the at least one of the augmented data or the event simulation to generate at least one digital twin metric; and compare the at least one digital twin metric to an acceptable metric threshold to determine whether the at least one digital twin metric meets the acceptable metric threshold. In some embodiments, the processing device is further configured to implement, in response to the at least one digital twin metric meeting the acceptable metric threshold, the digital twin to a digital environment. In some embodiments, the processing device is further configured to: regenerate, in response to the at least one digital twin metric not meeting the acceptable metric threshold, an updated synthetic sensor data by the on-demand synthetic data generator; and generate, based on the resource sensor data from the plurality of sensors and the updated synthetic sensor data, an updated digital twin of the resource. In some embodiments, the acceptable metric threshold is based on at least one of a similar digital twin associated with a similar resource of the resource.

In some embodiments, the plurality of sensors is configured to collect telemetry data.

In some embodiments, the processing device is further configured to determine the presence of at least one sensor anomaly based on comparing each resource sensor data of each sensor of the plurality of sensors associated with the resource.

In some embodiments, the processing device is further configured to: determine, by the sensor data analyzer engine, the resource sensor data from the plurality of sensors do not comprise the at least one sensor anomaly; and generate, based on the resource sensor data from the plurality of sensors, the digital twin of the resource.

In another aspect, a computer program product for generating a digital twin of a resource using partial sensor data and artificial intelligence is provided. In some embodiments, the the computer program product may comprise at least one non-transitory computer-readable medium having computer-readable program code portions embodied therein, the computer-readable program code portions which when executed by a processing device are configured to cause the processor to: receive resource sensor data from a plurality of sensors, wherein the plurality of sensors is associated with a resource; apply a sensor data analyzer engine to the resource sensor data; determine, by the sensor data analyzer engine, whether at least one sensor anomaly of the resource sensor data is present; apply an on-demand synthetic data generator to the at least one sensor anomaly; generate, by the on-demand synthetic data generator, synthetic sensor data associated with the resource, wherein the synthetic sensor data is based on a real-time pattern of the resource sensor data from the plurality of sensors; and generate, based on the resource sensor data from the plurality of sensors and the synthetic sensor data, a digital twin of the resource.

In some embodiments, the processing device is configured to cause the processor to generate a pattern of resource sensor data based on the resource sensor data, wherein the resource sensor data is received at a present time; and generate, based on the pattern of resource sensor data, the synthetic sensor data.

In some embodiments, the processing device is configured to cause the processor to: apply, in response to the generation of the digital twin, at least one of an augmented data or an event simulation to the digital twin; test the digital twin based on the application of the at least one of the augmented data or the event simulation to generate at least one digital twin metric; and compare the at least one digital twin metric to an acceptable metric threshold to determine whether the at least one digital twin metric meets the acceptable metric threshold. In some embodiments, the processing device is configured to cause the processor to implement, in response to the at least one digital twin metric meeting the acceptable metric threshold, the digital twin to a digital environment. In some embodiments, the processing device is configured to cause the processor to regenerate, in response to the at least one digital twin metric not meeting the acceptable metric threshold, an updated synthetic sensor data by the on-demand synthetic data generator; and generate, based on the resource sensor data from the plurality of sensors and the updated synthetic sensor data, an updated digital twin of the resource.

In another aspect, a computer-implemented method for generating a digital twin of a resource using partial sensor data and artificial intelligence is provided. In some embodiments, the computer-implemented method may comprise: receiving resource sensor data from a plurality of sensors, wherein the plurality of sensors is associated with a resource; applying a sensor data analyzer engine to the resource sensor data; determining, by the sensor data analyzer engine, whether at least one sensor anomaly of the resource sensor data is present; applying an on-demand synthetic data generator to the at least one sensor anomaly; generating, by the on-demand synthetic data generator, synthetic sensor data associated with the resource, wherein the synthetic sensor data is based on a real-time pattern of the resource sensor data from the plurality of sensors; and generating, based on the resource sensor data from the plurality of sensors and the synthetic sensor data, a digital twin of the resource.

In some embodiments, the computer-implemented method may further comprise: generating a pattern of resource sensor data based on the resource sensor data, wherein the resource sensor data is received at a present time; and generating, based on the pattern of resource sensor data, the synthetic sensor data.

In some embodiments, the computer-implemented method may further comprise: applying, in response to the generation of the digital twin, at least one of an augmented data or an event simulation to the digital twin; testing the digital twin based on the application of the at least one of the augmented data or the event simulation to generate at least one digital twin metric; and comparing the at least one digital twin metric to an acceptable metric threshold to determine whether the at least one digital twin metric meets the acceptable metric threshold. In some embodiments, the computer-implemented method may further comprise implementing, in response to the at least one digital twin metric meeting the acceptable metric threshold, the digital twin to a digital environment.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment generating a digital twin of a resource using partial sensor data and artificial intelligence, in accordance with an embodiment of the disclosure;

FIG. 2 illustrates technical components of an exemplary artificial intelligence subsystem, in accordance with an embodiment of the disclosure;

FIG. 3 illustrates a process flow for generating a digital twin of a resource using partial sensor data and artificial intelligence, in accordance with an embodiment of the disclosure;

FIG. 4 illustrates a process flow for generating the digital twin of the resource based on the resource sensor data from the plurality of sensors, in accordance with an embodiment of the disclosure;

FIG. 5 illustrates a process flow for training the sensor data analyzer engine, in accordance with an embodiment of the disclosure; and

FIG. 6 illustrates a process flow for generating a digital twin and/or an updated digital twin of the resource, in accordance with an embodiment of the disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like.

As described in further detail above, managers and users of digital environments, such as a metaverse environment, may wish to accurately capture real-world resources as digital resources for the digital environment, but may have difficulty when certain hardware components used to generate these digital resources are not functioning correctly. For instance, and where a plurality of sensors may be used to capture the characteristics of the resource, then the issue may arise where at least one of the sensors is not functioning correctly so the digital resource cannot be generated accurately. The issue may further be exacerbated when the sensors are interconnected to gather system logs and gather telemetry data, thus when one sensor malfunctions, the overall system may be impacted. Thus, there exists a need to implement a system that accurately generate digital resources for a digital environment even when at least one sensor is malfunctioning.

As described in further detail herein, the present disclosure provides a solution to the above-referenced problems in the field of technology by generating a digital twin of a real-world resource for a virtual/digital environment (e.g., a metaverse environment). For instance, the digital resource generation system may collect data from a plurality of hardware devices, such as sensors which have been designed to collect telemetry data of the real-world resource, to feed into a data analyzer such as an artificial intelligence engine which can determine whether anomalies in the data are present (e.g., where a sensor is acting incorrectly) or whether there are no anomalies and the data can be used to generate the digital twin of the real-world resource. In the instance where anomalies are detected, the digital resource generation system may use an on-demand intelligence agent to generate synthetic data based on recorded patterns of similar telemetry data collected for the resource, in real-time. Such synthetic data may be used to supplement the anomalous data and generate the digital twin of the resource. Once the digital twin has been generated, the digital resource generation system may apply augmented data and/or event simulation data to the digital twin to test whether the digital twin overcomes an acceptance threshold. Based on the acceptance threshold data, the system may determine the digital resource is good enough for implementation or whether the data should be fed back into the digital resource generation system to further perfect the digital twin generation (e.g., when the digital twin does not meet the acceptance threshold).

Accordingly, the present disclosure comprises a digital resource generation system which is configured to receive resource sensor data from a plurality of sensors, wherein the plurality of sensors is associated with a resource (e.g., the plurality of sensors may be pointed toward the resource, are near the resource, are configured to consider the resource, and/or the like); apply a sensor data analyzer engine to the resource sensor data; determine, by the sensor data analyzer engine, whether at least one sensor anomaly of the resource sensor data is present; apply an on-demand synthetic data generator to the at least one sensor anomaly; generate, by the on-demand synthetic data generator, synthetic sensor data associated with the resource, wherein the synthetic sensor data is based on a real-time pattern of the resource sensor data from the plurality of sensors (e.g., the functioning sensors and their associated resource sensor data); and generate, based on the resource sensor data from the plurality of sensors and the synthetic sensor data, a digital twin of the resource.

What is more, the present invention provides a technical solution to a technical problem. As described herein, the technical problem includes the accurate and efficient generation of a digital resource, even where a sensor is malfunctioning. The technical solution presented herein allows for the accurate and efficient generation of the digital resource using resource sensor data from functioning sensors and synthetic sensor data using artificial intelligence, generated in real-time. In particular, the digital resource generation system is an improvement over existing solutions to the generation of digital resources, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

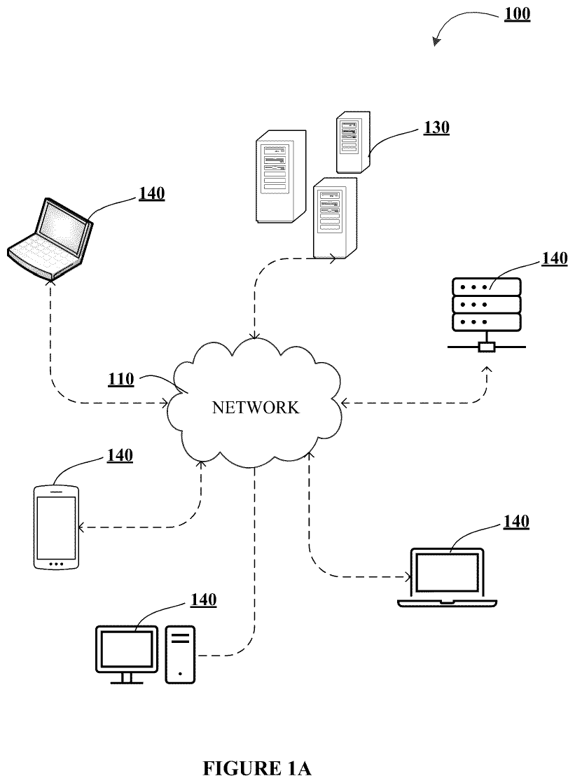

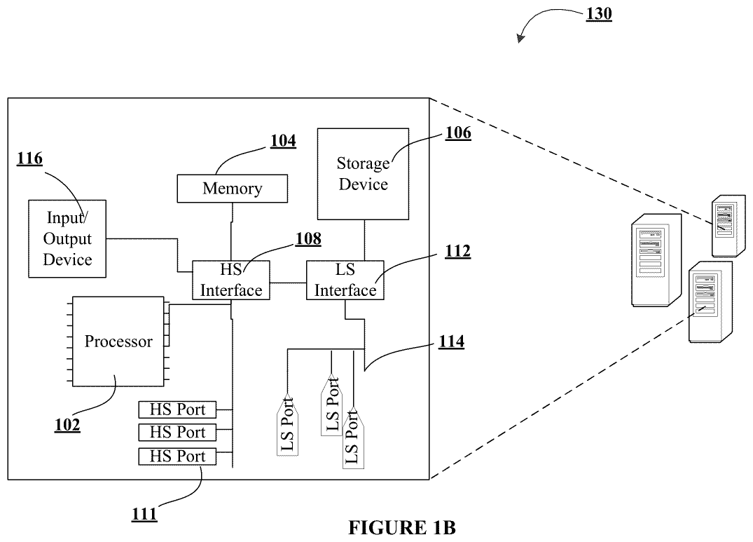

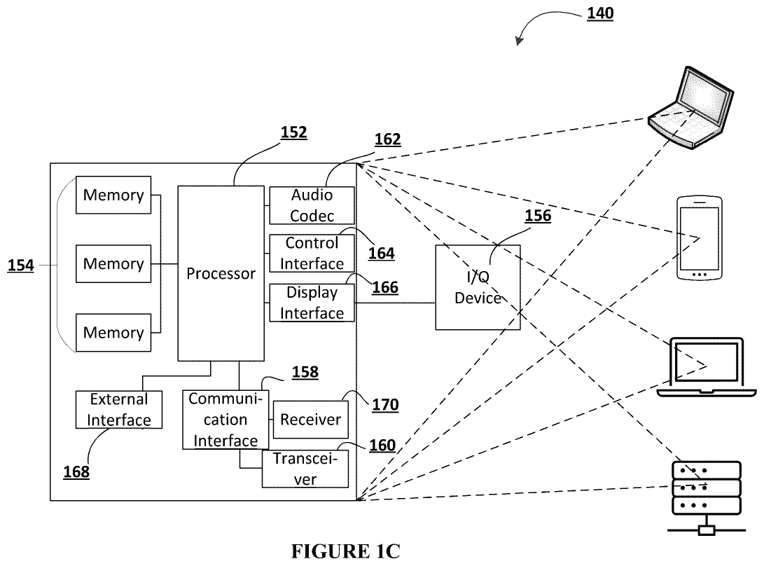

FIGS. 1A-1C illustrate technical components of an exemplary distributed computing environment for generating a digital twin of a resource using partial sensor data and artificial intelligence 100, in accordance with an embodiment of the invention. As shown in FIG. 1A, the distributed computing environment 100 contemplated herein may include a system 130 (i.e., a digital twin generation), an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 (shown as “LS Interface”) connecting to low speed bus 114 (shown as “LS Port”) and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 (shown as “HS Interface”) is coupled to memory 104, input/output (I/O) device 116 (e.g., through a graphics processor or accelerator), and to high-speed expansion ports 111 (shown as “HS Port”), which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

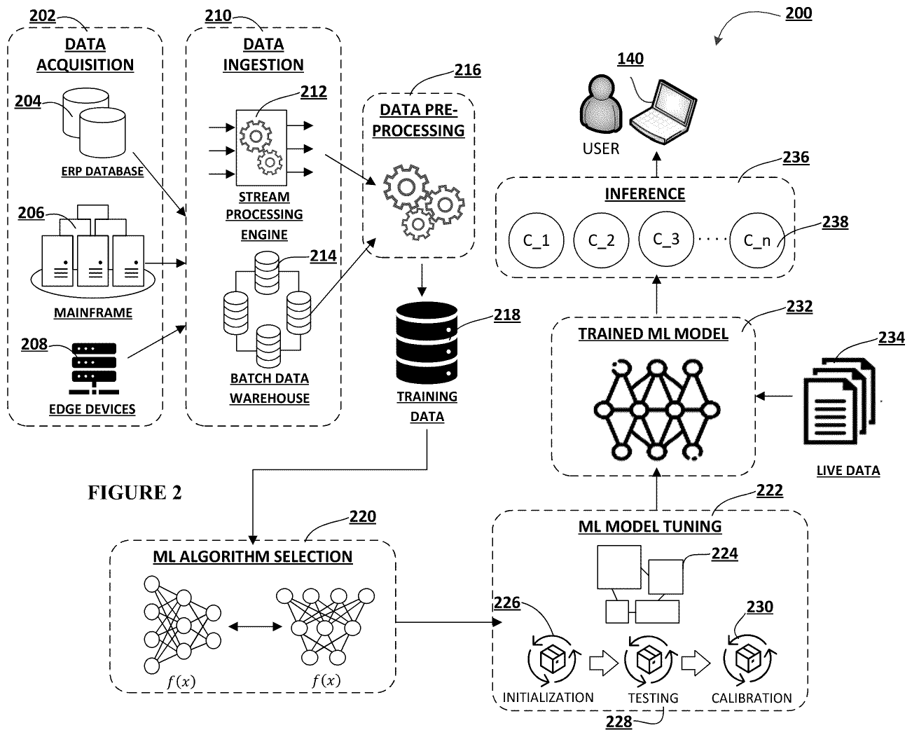

FIG. 2 illustrates an exemplary artificial intelligence (AI) engine subsystem architecture 200, in accordance with an embodiment of the invention. The artificial intelligence subsystem 200 may include a data acquisition engine 202, data ingestion engine 210, data pre-processing engine 216, AI engine tuning engine 222, and inference engine 236.

The data acquisition engine 202 may identify various internal and/or external data sources to generate, test, and/or integrate new features for training the artificial intelligence engine 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering.

In artificial intelligence, the quality of data and the useful information that can be derived therefrom directly affects the ability of the artificial intelligence engine 224 to learn. The data pre-processing engine 216 may implement advanced integration and processing steps needed to prepare the data for artificial intelligence execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of artificial intelligence algorithm being used, this training data 218 may require further enrichment. For example, in supervised learning, the training data is enriched using one or more meaningful and informative labels to provide context so a artificial intelligence engine can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The AI tuning engine 222 may be used to train an artificial intelligence engine 224 using the training data 218 to make predictions or decisions without explicitly being programmed to do so. The artificial intelligence engine 224 represents what was learned by the selected artificial intelligence algorithm 220 and represents the rules, numbers, and any other algorithm-specific data structures required for classification. Selecting the right artificial intelligence algorithm may depend on a number of different factors, such as the problem statement and the kind of output needed, type and size of the data, the available computational time, number of features and observations in the data, and/or the like. Artificial intelligence algorithms may refer to programs (math and logic) that are configured to self-adjust and perform better as they are exposed to more data. To this extent, artificial intelligence algorithms are capable of adjusting their own parameters, given feedback on previous performance in making prediction about a dataset.

The artificial intelligence algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable artificial intelligence engine type. Each of these types of artificial intelligence algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

To tune the artificial intelligence engine, the AI tuning engine 222 may repeatedly execute cycles of experimentation 226, testing 228, and tuning 230 to optimize the performance of the artificial intelligence algorithm 220 and refine the results in preparation for deployment of those results for consumption or decision making. To this end, the AI tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the engine is the measurement used to determine which set of hyperparameters is best at identifying relationships and patterns between variables in a dataset based on the input, or training data 218. A fully trained artificial intelligence engine 232 is one whose hyperparameters are tuned and engine accuracy maximized.

The trained artificial intelligence engine 232, similar to any other software application output, can be persisted to storage, file, memory, or application, or looped back into the processing component to be reprocessed. More often, the trained artificial intelligence engine 232 is deployed into an existing production environment to make practical business decisions based on live data 234. To this end, the artificial intelligence subsystem 200 uses the inference engine 236 to make such decisions. The type of decision-making may depend upon the type of artificial intelligence algorithm used. For example, artificial intelligence engines trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, artificial intelligence engines trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, artificial intelligence engines that perform regression techniques may use live data 234 to predict or forecast continuous outcomes.

It will be understood that the embodiment of the artificial intelligence subsystem 200 illustrated in FIG. 2 is exemplary and that other embodiments may vary. As another example, in some embodiments, the artificial intelligence subsystem 200 may include more, fewer, or different components.

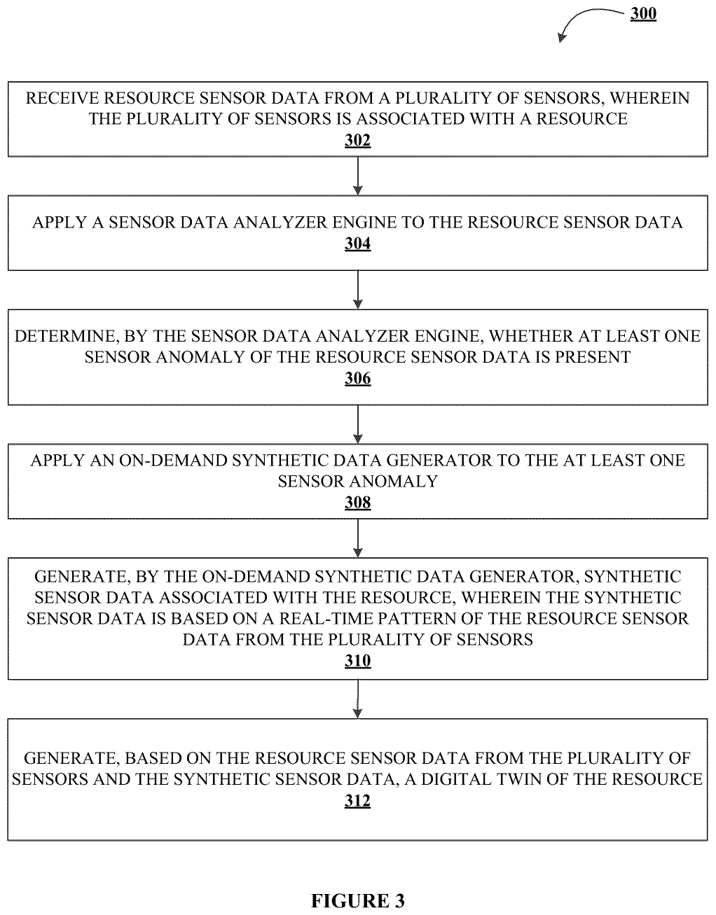

FIG. 3 illustrates a process flow 300 for generating a digital twin of a resource using partial sensor data and artificial intelligence, in accordance with an embodiment of the invention. In some embodiments, a system (e.g., similar to one or more of the systems described herein with respect to FIGS. 1A-1C) may perform one or more of the steps of process flow 300. For example, a digital twin generation system (e.g., the system 130 described herein with respect to FIG. 1A-1C) may perform the steps of process 300. In some embodiments, an artificial intelligence engine (e.g., such as a sensor data analyzer engine and/or an on-demand synthetic data generator) may perform some or all of the steps described in process flow 300.

As shown in block 302, the process flow 300 may include the step of receiving resource sensor data from a plurality of sensors, wherein the plurality of sensors is associated with a resource. By way of non-limiting example, the digital twin generation system may receive resource sensor data from a plurality of sensors located near and/or around a real-world resource, such as a physical resource.

For instance, the plurality of sensors may be configured to capture data regarding the real-world resource, such as telemetry data comprising data regarding at least one of heat data, metric data (e.g., physical dimensions or measurements of the resource), relationship data (e.g., where the resource is a human and the sensors may collect data regarding the resource's relationships to other humans such as parent data, family data, teacher/professor data, friendship/acquaintance data, and/or the like), ranking data (e.g., ranking as compared to other resources, such as based on a grade, a measurement, a competition, based on IQ, and/or the like), infrastructure data (e.g., infrastructure of where the resource is located, infrastructure of a particular organization of other resources to the resource such as a learning infrastructure comprising classes, instructions, interaction with other resources, and/or the like), and/or the like. Thus, and in some embodiments, the digital twin generation system may be configured to collect a plurality of different types of data regarding each resource, whereby a complete picture of the resource and its interactions with its environment are collected by the plurality of sensors and transmitted to the digital twin generation system for parsing and interpretation.

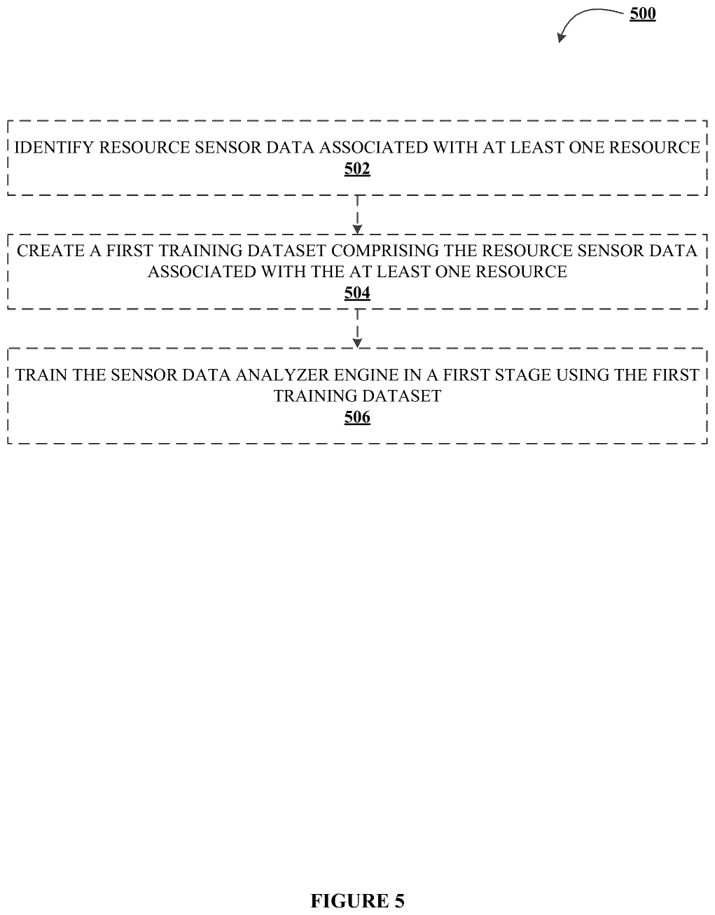

As shown in block 304, the process flow 300 may include the step of applying a sensor data analyzer engine to the resource sensor data. By way of non-limiting example, the data received from the plurality of sensors may be applied as an input to a sensor data analyzer engine, whereby the sensor data analyzer engine has been configured to determine whether any of the sensors of the plurality of sensors are not working correctly (i.e., not working at all, are working but are generating dissimilar data as compared to the other sensors of the plurality of sensors, and/or the like). In some embodiments, the sensor data analyzer engine is pre-trained to consider the data input (e.g., the data from the plurality of sensors), compare each of the data input from the plurality of sensors, and determine whether anomalies are present. In some embodiments, no anomalies may be detected, a single anomaly may be detected, and/or a plurality of anomalies may be detected. The potential training of the sensor data analyzer engine is discussed in further detail below with respect to FIG. 5.

As shown in block 306, the process flow 300 may include the step of determining, by the sensor data analyzer engine whether at least one sensor anomaly of the resource sensor data is present. By way of non-limiting example, the digital twin generation system may determine the presence of a sensor anomaly when the data from each sensor of the plurality of sensors comprises at least one different data output when compared against the other data outputs of the other sensors in the plurality of sensors. For instance, such a different data output may comprise no reading by the at least one sensor (e.g., indicating the sensor cannot get a reading of the resource which may be due to the sensor not being powered on, the sensor not comprising working components, and/or the like) and/or may comprise a completely different reading as compared to the other sensors of the plurality of sensors (e.g., where at least one sensor reads a heat of −5 degrees Celsius, but the other sensors associated with the resource are reading 80 degrees Celsius).

As shown in block 308, the process flow 300 may include the step of applying an on-demand synthetic data generator to the at least one sensor anomaly. By way of non-limiting example, the digital twin generation system may apply—in response to the digital twin generation system determining the presence of the at least one sensor anomaly—an on-demand synthetic data generator to the at least one sensor anomaly in order to generate at least one synthetic sensor data to take the place of the sensor anomaly data. For instance, the on-demand synthetic data generator may be configured to generate synthetic sensor data for the sensor that is working incorrectly, such that the synthetic sensor data is generated in real-time and immediately. In some embodiments, the on-demand synthetic data generator may be an artificial intelligence engine, similar to the artificial intelligence engine shown and described in FIG. 2 and/or such as that described with respect to the sensor data analyzer engine.

As shown in block 310, the process flow 300 may include the step of generating—by the on-demand synthetic data generator—synthetic sensor data associated with the resource, wherein the synthetic sensor data is based on a real-time pattern of the resource sensor data from the plurality of sensors. By way of non-limiting example, the digital twin generation system may comprise an on-demand synthetic data generator which is configured to consider each of the other sensor outputs and data for each of the plurality of sensors and determine a real-time pattern of the resource sensor data from the sensors acting correctly. Based on such a real-time pattern, the on-demand synthetic data generator may generate the synthetic sensor data based on similar data output from the working sensor(s), such that the synthetic sensor data closely resembles the sensor data of the correctly working sensors.

In some embodiments, the on-demand synthetic data generator may be configured to consider only certain sensor outputs comprising particular portions of the resource when generating the synthetic sensor data. For instance, and where the resource comprises at least two dimensions that are the same (e.g., the resource comprises the same measurements for multiple sides of the resource) and the sensor that is not working correctly is adjacent to sensors that comprise the same adjacent sensor outputs as the adjacent sensors to the at least two similar dimensions sensors, then the on-demand synthetic data generator may generate the synthetic sensor data to comprise the same measurement as the at least two dimensions. Thus, and in some embodiments, the on-demand synthetic data generator may determine the sensor that is generating incorrect sensor data is in a similar position and considering a similar portion of the resource to another sensor of the plurality of sensors that is generating non-anomalous sensor data (i.e., the resource sensor data from the plurality of sensors), which may be copied and/or modeled after for the synthetic sensor data.

As shown in block 312, the process flow 300 may include the step of generating, based on the resource sensor data from the plurality of sensors and the synthetic sensor data, a digital twin of the resource. By way of non-limiting example, the digital twin generation system may generate a digital twin of the real-world resource for a virtual electronic environment (e.g., such as a metaverse environment) based on the combination of the resource sensor data from the plurality of sensors and synthetic sensor data. Thus, the digital twin of the resource may comprise the same and/or similar characteristics (e.g., similar to the characteristics of the real-world resource, but similar based on the synthetic sensor data) rendered for a virtual electronic environment.

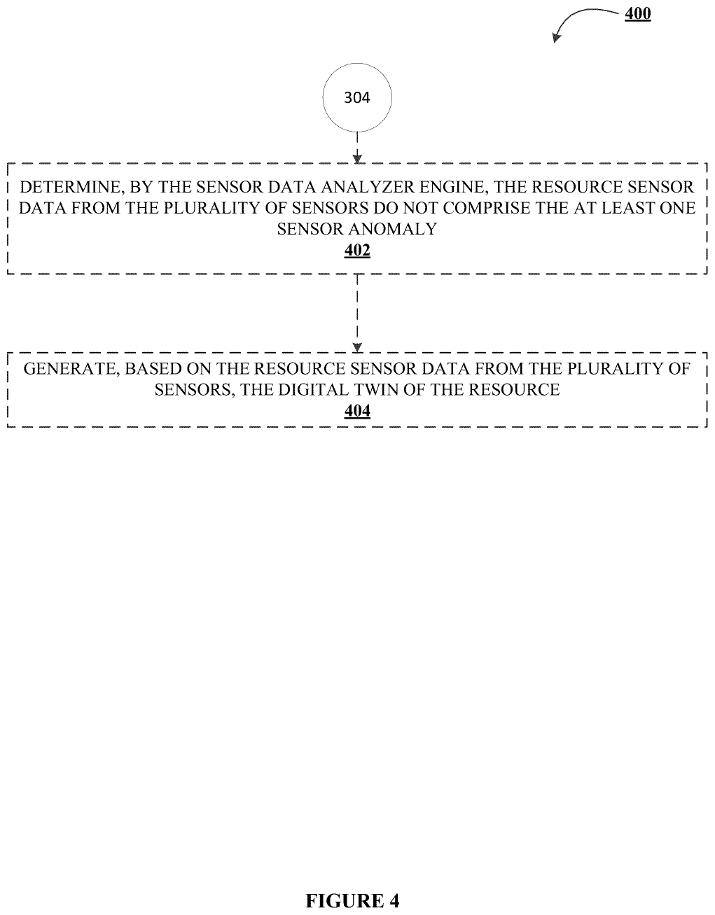

FIG. 4 illustrates a process flow 400 for generating the digital twin of the resource based on the resource sensor data from the plurality of sensors, in accordance with an embodiment of the invention. In some embodiments, a system (e.g., similar to one or more of the systems described herein with respect to FIGS. 1A-1C) may perform one or more of the steps of process flow 400. For example, a digital twin generation system (e.g., the system 130 described herein with respect to FIG. 1A-1C) may perform the steps of process 400. In some embodiments, an artificial intelligence engine (e.g., such as a sensor data analyzer engine and/or the on-demand synthetic data generator) may perform some or all of the steps described in process flow 400.

In some embodiments, and as shown in block 402, the process flow 400 may include the step of determining, by the sensor data analyzer engine, the resource sensor data from the plurality of sensors do not comprise the at least one sensor anomaly. The process described herein with respect to blocks 402 and 404 may proceed after the process described with respect to block 304 of FIG. 3. By way of non-limiting example, the digital twin generation system may determine each of the sensors associated with the resource are operating correctly and do not comprise any abnormalities based on the determination by the sensor data analyzer engine.

In some embodiments, and as shown in block 404, the process flow 400 may include the step of generating, based on the resource sensor data from the plurality of sensors, the digital twin of the resource. By way of non-limiting example, the digital twin generation system may generate the digital twin of the resource for a virtual electronic environment, whereby the digital twin of the resource may match the characteristics of the real-world resource based on the data generated by the plurality of sensors.

FIG. 5 illustrates a process flow 500 for training the sensor data analyzer engine, in accordance with an embodiment of the invention. In some embodiments, a system (e.g., similar to one or more of the systems described herein with respect to FIGS. 1A-1C) may perform one or more of the steps of process flow 500. For example, a digital twin generation system (e.g., the system 130 described herein with respect to FIG. 1A-1C) may perform the steps of process 500. In some embodiments, an artificial intelligence engine (e.g., such as a sensor data analyzer engine and/or the on-demand synthetic data generator) may perform some or all of the steps described in process flow 500.

In some embodiments, and as shown in block 502, the process flow 500 may include the step of identifying resource sensor data associated with at least one resource. By way of non-limiting example, the digital twin generation system may identify previous instances of collecting and/or generating resource sensor data of a plurality of resources, whereby the previous instances may comprise all historical instances where the digital twin generation system has been in use. Thus, the digital twin generation system may be configured to keep a detailed recording of each of the resource sensor data collected for each of the resources it has been configured to generate a digital twin.

In some embodiments, the digital twin generation system may be configured to only collect the resource sensor data for particular resources of the same or similar type (e.g., the same physical resource and/or similar physical resource). In this manner, and as explained in further detail below, the sensor data analyzer engine may be trained based on each type of resource, individually, rather than a plurality of different resources.

In some embodiments, and as shown in block 504, the process flow 500 may include the step of creating a first training dataset comprising the resource sensor data associated with the at least one resource. By way of non-limiting example, the digital twin generation system may collect and create a first training dataset comprising the resource sensor data for all the resources the digital twin generation system has been configured to generate a digital twin for and/or the resource sensor data for a particular resource that the digital twin generation system has been configured to generate a digital twin for. In some embodiments, the digital twin generation system may be configured to create a plurality of training datasets at pre-determined intervals, such that the plurality of training datasets are created at pre-determined intervals and based on the most recent resource sensor data received between each interval of the pre-determined intervals. In this manner, the resource sensor data may be collected to create the training datasets continuously and the training datasets are applied to the sensor data analyzer engine for continuous training and fine-tuning.

In some embodiments, and as shown in block 506, the process flow 500 may include the step of training the sensor data analyzer engine in a first stage using the first training dataset. For instance, the sensor data analyzer may be trained at least at a first time by applying the first training dataset to the sensor data analyzer. In some embodiments, the sensor data analyzer may be continuously trained by applying a plurality of training datasets comprising the historical resource sensor data received.

In some embodiments, the sensor data analyzer may further be trained by feedback from a user of the digital twin generation system, a manager of the digital twin generation system, a manager of the resource associated with the resource sensor data, and/or the like. Thus, and in some embodiments, the sensor data analyzer may make its determination of whether the resource sensor data comprises an anomaly and a user of the digital twin generation system, a manager of the digital twin generation system, a manager of the resource associated with the resource sensor data, may input their own determination, which will be used to further train the sensor data analyzer engine.

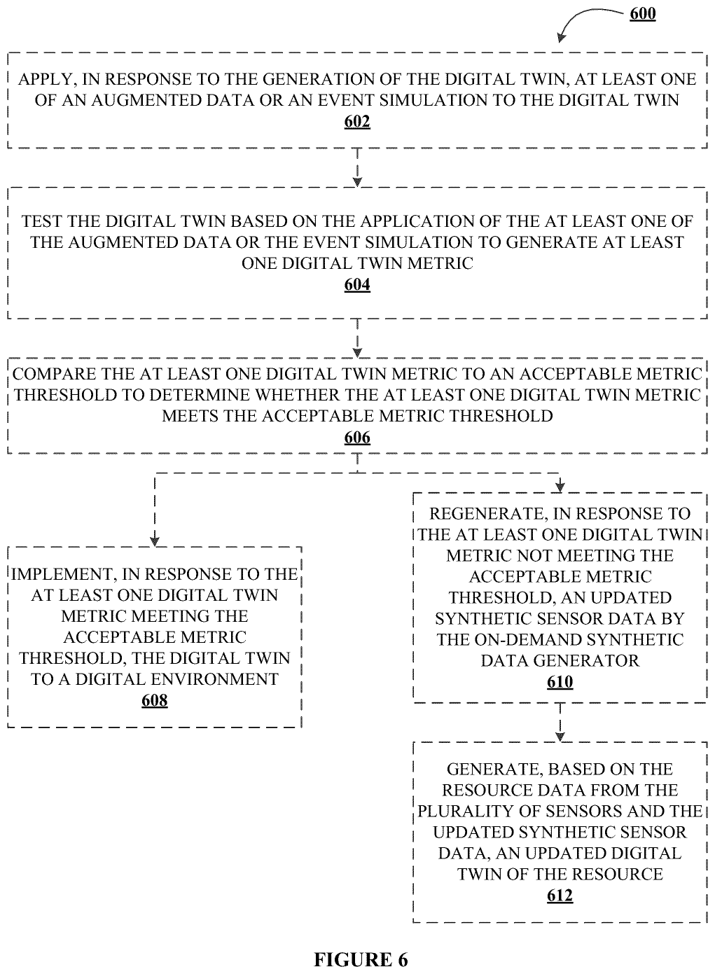

FIG. 6 illustrates a process flow 600 for generating a digital twin and/or an updated digital twin of the resource, in accordance with an embodiment of the invention. In some embodiments, a system (e.g., similar to one or more of the systems described herein with respect to FIGS. 1A-1C) may perform one or more of the steps of process flow 600. For example, a digital twin generation system (e.g., the system 130 described herein with respect to FIG. 1A-1C) may perform the steps of process 600. In some embodiments, an artificial intelligence engine (e.g., such as a sensor data analyzer engine and/or the on-demand synthetic data generator) may perform some or all of the steps described in process flow 600.

In some embodiments, and as shown in block 602, the process flow 600 may include the step of applying, in response to the generation of the digital twin, at least one of an augmented data or an event simulation to the digital twin. By way of non-limiting example, the digital twin generation system may apply at least one of an augmented data and/or an event simulation to the digital twin to test the digital twin before implementing the digital twin the digital environment.

As used herein, the term augmented data refers to the alteration of the resource sensor data and/or synthetic sensor data used to generate the digital twin, whereby the altered data may be changed slightly from the previous resource sensor data and/or synthetic sensor data used in a previous iteration to generate the digital twin (e.g., an immediate previous instance where the digital twin was generated and the associated resource sensor data and synthetic sensor data). In this manner, the augmented data may be used by the digital twin generation system to test whether the currently generated digital twin meets a particular threshold (i.e., an acceptable metric threshold) to be implemented in the digital environment. In some embodiments, the augmented data may be used by the digital twin generation system to determine whether a slightly different synthetic sensor data would generate a better digital twin (i.e., closer to the real-world resource). In some embodiments, the augmented data may be applied to the resource sensor data and the synthetic sensor data to determine whether the previously generated digital twin is better than the digital twin using the augmented data.

As used herein, the term event simulation refers to a simulated interaction with the digital twin (e.g., a simulated interaction within the digital environment and/or a simulated version of the digital environment which is designed for testing purposes) to determine whether the digital twin may be implemented in the digital environment. In some embodiments, the event simulation may comprise a user's interaction with the digital resource in the digital testing environment, whereby the user's interaction may be used to determine whether the digital resource closely resembles the real-world resource. In some embodiments, the event simulation may comprise a computer processor's action(s) in interacting with the digital twin, including but not limited to simulating events of interrogating the data of the digital twin and determining whether the characteristics of the digital twin are optimal as compared to what is expected and to other digital resources.

In some embodiments, and as shown in block 604, the process flow 600 may include the step of testing the digital twin based on the application of the at least one of the augmented data or the event simulation to generate at least one digital twin metric. By way of non-limiting example, the digital twin generation system may test the digital twin by applying the augmented data and/or the event simulation to generate a digital twin metric. In some embodiments, the digital twin metric may comprise a rating of the digital twin based on testing the digital twin (e.g., a numerical rating, and/or the like), a percentage level from 0-100%, a grade rating (e.g., A, B, C, D, F, and/or the like), and/or the like. In some embodiments, the testing may generate the digital twin metric to be higher (e.g., a higher number, a higher percentage, a higher grade level, and/or the like) when the testing using the augmented data and/or the event simulation shows the digital twin is likely similar enough to the real-world resource.

In some embodiments, and as shown in block 606, the process flow 600 may include the step of comparing the at least one digital twin metric to an acceptable metric threshold to determine whether the at least one digital twin metric meets the acceptable metric threshold. By way of non-limiting example, the acceptable metric threshold may be generated to determine whether the digital twin meets certain requirements by a user of the digital twin generation system, a manager of the digital twin generation system, a manager/owner of the resource associated with the digital twin, and/or the like. As used herein, the term comparing and/or compare refers to a one-to-one evaluation of the digital twin metric to the acceptable metric threshold to determine whether the number, value, percentage, grade, and/or the like meets and/or exceeds the acceptable metric threshold of the same type (e.g., number, value, percentage, grade, and/or the like).

In some embodiments, the acceptable metric threshold is based on at least one of a similar digital twin associated with a similar resource of the resource. For instance, the acceptable metric threshold may be based on other similar resources and associated digital twins, whereby the acceptable metric threshold is based on the metric thresholds generated for the other similar digital twins which were acceptable for the digital environment.

In some embodiments, and as shown in block 608, the process flow 600 may include the step of implementing, in response to the at least one digital twin metric meeting the acceptable metric threshold, the digital twin to the digital environment. Thus, and where the digital twin metric meets and/or exceeds the acceptable metric threshold, the associated digital twin may be implemented to the digital environment.

In some embodiments, and as shown in block 610, the process flow 600 may include the step of regenerating, in response to the at least one digital twin metric not meeting the acceptable metric threshold, an updated synthetic sensor data by the on-demand synthetic data generator. By way of non-limiting example, the data of the synthetic sensor data and the resource sensor data used to generate the original digital twin and/or the previous digital twin(s) (i.e., the digital twins for the resource that did not meet the acceptable metric threshold) may be used by the digital twin generation system (e.g., by the on-demand synthetic data generator) to generate an updated digital twin which may go through each of the processes described herein to determine whether the updated digital twin is acceptable to be implemented to the virtual electronic environment.

In some embodiments, and as shown in block 612, the process flow 600 may include the step of generating, based on the resource sensor data from the plurality of sensors and the updated synthetic sensor data, an updated digital twin of the resource. For instance, the on-demand synthetic data generator may be configured to take the previously used data of the synthetic sensor data and the resource sensor data for the previously generated digital, tweak the previously used data, and generate an updated digital twin to be tested using the same and/or similar event simulation and/or augmented data to determine if the updated digital twin should be implemented in the digital environment. In some embodiments, the on-demand synthetic data generator may be configured to tweak only the synthetic sensor data. However, and in some other embodiments, the on-demand synthetic data generator may be configured to tweak both the synthetic sensor data and the resource sensor data.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for generating a digital twin of a resource using partial sensor data and artificial intelligence, the system comprising:
a memory device with computer-readable program code stored thereon;
at least one processing device operatively coupled to the at least one memory device and the at least one communication device, wherein executing the computer-readable code is configured to cause the at least one processing device to:
receive resource sensor data from a plurality of sensors, wherein the plurality of sensors is associated with a resource;
apply a sensor data analyzer engine to the resource sensor data;
determine, by the sensor data analyzer engine, whether at least one sensor anomaly of the resource sensor data is present;
apply an on-demand synthetic data generator to the at least one sensor anomaly;
generate, by the on-demand synthetic data generator, synthetic sensor data associated with the resource, wherein the synthetic sensor data is based on a real-time pattern of the resource sensor data from the plurality of sensors; and
generate, based on the resource sensor data from the plurality of sensors and the synthetic sensor data, a digital twin of the resource.

2. The system of claim 1, wherein the on-demand synthetic data generator is configured to:
generate a pattern of resource sensor data based on the resource sensor data; and
generate, based on the pattern of resource sensor data, the synthetic sensor data.

3. The system of claim 1, wherein the processing device is further configured to:
identify resource sensor data associated with at least one resource;
create a first training dataset comprising the resource sensor data associated with the at least one resource; and
train the sensor data analyzer engine in a first stage using the first training dataset.

4. The system of claim 3, wherein the resource sensor data associated with the at least one resource comprises at least one of resource sensor data for one resource or resource sensor data for a plurality of resources.

5. The system of claim 1, wherein the processing device is further configured to:
apply, in response to the generation of the digital twin, at least one of an augmented data or an event simulation to the digital twin;
test the digital twin based on the application of the at least one of the augmented data or the event simulation to generate at least one digital twin metric; and
compare the at least one digital twin metric to an acceptable metric threshold to determine whether the at least one digital twin metric meets the acceptable metric threshold.

6. The system of claim 5, wherein the processing device is further configured to implement, in response to the at least one digital twin metric meeting the acceptable metric threshold, the digital twin to a digital environment.

7. The system of claim 5, wherein the processing device is further configured to:
regenerate, in response to the at least one digital twin metric not meeting the acceptable metric threshold, an updated synthetic sensor data by the on-demand synthetic data generator; and
generate, based on the resource sensor data from the plurality of sensors and the updated synthetic sensor data, an updated digital twin of the resource.

8. The system of claim 5, wherein the acceptable metric threshold is based on at least one of a similar digital twin associated with a similar resource of the resource.

9. The system of claim 1, wherein the plurality of sensors is configured to collect telemetry data.

10. The system of claim 1, wherein the processing device is further configured to determine the presence of at least one sensor anomaly based on comparing each resource sensor data of each sensor to each resource sensor data of the plurality of sensors associated with the resource.

11. The system of claim 1, wherein the processing device is further configured to:
determine, by the sensor data analyzer engine, the resource sensor data from the plurality of sensors do not comprise the at least one sensor anomaly; and
generate, based on the resource sensor data from the plurality of sensors, the digital twin of the resource.

12. A computer program product for generating a digital twin of a resource using partial sensor data and artificial intelligence, wherein the computer program product comprises at least one non-transitory computer-readable medium having computer-readable program code portions embodied therein, the computer-readable program code portions which when executed by a processing device are configured to cause the processor to:
receive resource sensor data from a plurality of sensors, wherein the plurality of sensors is associated with a resource;
apply a sensor data analyzer engine to the resource sensor data;
determine, by the sensor data analyzer engine, whether at least one sensor anomaly of the resource sensor data is present;
apply an on-demand synthetic data generator to the at least one sensor anomaly;
generate, by the on-demand synthetic data generator, synthetic sensor data associated with the resource, wherein the synthetic sensor data is based on a real-time pattern of the resource sensor data from the plurality of sensors; and
generate, based on the resource sensor data from the plurality of sensors and the synthetic sensor data, a digital twin of the resource.

13. The computer program product of claim 12, wherein the processing device is configured to cause the processor to:
generate a pattern of resource sensor data based on the resource sensor data; and
generate, based on the pattern of resource sensor data, the synthetic sensor data.

14. The computer program product of claim 12, wherein the processing device is configured to cause the processor to:
apply, in response to the generation of the digital twin, at least one of an augmented data or an event simulation to the digital twin;
test the digital twin based on the application of the at least one of the augmented data or the event simulation to generate at least one digital twin metric; and
compare the at least one digital twin metric to an acceptable metric threshold to determine whether the at least one digital twin metric meets the acceptable metric threshold.

15. The computer program product of claim 14, wherein the processing device is configured to cause the processor to implement, in response to the at least one digital twin metric meeting the acceptable metric threshold, the digital twin to a digital environment.

16. The computer program product of claim 14, wherein the processing device is configured to cause the processor to:
regenerate, in response to the at least one digital twin metric not meeting the acceptable metric threshold, an updated synthetic sensor data by the on-demand synthetic data generator; and
generate, based on the resource sensor data from the plurality of sensors and the updated synthetic sensor data, an updated digital twin of the resource.

17. A computer-implemented method for generating a digital twin of a resource using partial sensor data and artificial intelligence, the computer-implemented method comprising:
receiving resource sensor data from a plurality of sensors, wherein the plurality of sensors is associated with a resource;
applying a sensor data analyzer engine to the resource sensor data;
determining, by the sensor data analyzer engine, whether at least one sensor anomaly of the resource sensor data is present;
applying an on-demand synthetic data generator to the at least one sensor anomaly;
generating, by the on-demand synthetic data generator, synthetic sensor data associated with the resource, wherein the synthetic sensor data is based on a real-time pattern of the resource sensor data from the plurality of sensors; and
generating, based on the resource sensor data from the plurality of sensors and the synthetic sensor data, a digital twin of the resource.

18. The computer-implemented method of claim 17, further comprising:
generating a pattern of resource sensor data based on the resource sensor data; and
generating, based on the pattern of resource sensor data, the synthetic sensor data.

19. The computer-implemented method of claim 17, further comprising:
applying, in response to the generation of the digital twin, at least one of an augmented data or an event simulation to the digital twin;
testing the digital twin based on the application of the at least one of the augmented data or the event simulation to generate at least one digital twin metric; and
comparing the at least one digital twin metric to an acceptable metric threshold to determine whether the at least one digital twin metric meets the acceptable metric threshold.

20. The computer-implemented method of claim 19, further comprising implementing, in response to the at least one digital twin metric meeting the acceptable metric threshold, the digital twin to a digital environment.
